(19) United States
(12) Patent Application Publication
(10) Pub. No.: US 2022/0073131 A1
(43) Pub. Date: Mar. 10, 2022

(54) ELECTRONIC CONTROL DEVICE WITH SHORT-CIRCUIT PROTECTION FOR ACTUATING AN ELECTRIC MOTOR OF AN ELECTROMECHANICAL MOTOR VEHICLE STEERING SYSTEM

(71) Applicants: thyssenkrupp Presta AG, Eschen (LI); thyssenkrupp AG, Essen (DE)

(72) Inventors: Janos LOECHER, Budapest (HU); Adam NEVERI, Ajka (HU)

(73) Assignees: thyssenkrupp Presta AG, Eschen (LI); thyssenkrupp AG, Essen (DE)

(21) Appl. No.: 17/416,239

(22) PCT Filed: Jan. 3, 2020
(86) PCT No.: PCT/EP2020/050099

§ 371 Date: Jun. 18, 2021

(30) Foreign Application Priority Data
Jan. 7, 2019 (DE) 10 2019 200 091.6

(51) Int. Cl. B62D 5/04; H02H 1/00; H02H 7/08

(52) U.S. Cl. CPC B62D 5/0487; H02H 7/08; H02H 1/0007

(57) ABSTRACT

An electronic control device with short-circuit protection for actuating an electric motor may include a switching device that is connectable to a power source and a power module coupled to the switching device and configured to be coupled to the electric motor for supplying electrical power. The power module contains an inverter and a capacitor connected in parallel. A current-measuring device may be connected to the power module and configured to output a short-circuit fault signal based on the intensity of electric current in the power module. A control unit connected to the current-measuring device may control the switching device, with the control unit configured to isolate the power module from the power source via the switching device upon the short-circuit fault signal. The current-measuring device may measure an electric current flowing through the capacitor and output the short-circuit fault signal based on a direct-current component of the measured current.

The invention relates to an electronic control device with short-circuit protection for actuating an electric motor of an electromechanical motor-vehicle steering system, according to the preamble of claim 1.

Electronic control devices with short-circuit protection for actuating electric motors exhibit a protective mechanism, in order to isolate the control device from the connected power source in the case of a short circuit within the control device. Such a protective mechanism is particularly advantageous if the control device is being fed by a mobile power source—such as a battery, for instance—independently of the electricity grid. A short circuit in a control unit of a motor vehicle—for instance, in the control device of an electromechanical motor-vehicle steering system—can lead to a drop in the voltage of the vehicle battery and can discharge the latter within a short time to such an extent that the other electrical components of the electrical system of the vehicle can no longer be operated properly.

Electronic control devices for actuating an electric motor of an electromechanical motor-vehicle steering system ordinarily exhibit a three-phase inverter, for supplying an electric motor taking the form of a three-phase motor, and at least one charging capacitor connected in parallel therewith, in order to provide for the rapidly fluctuating current demand of the inverter. The main causes of a short circuit in the control device are faults of the switching elements being used in the inverter, or in the charging capacitors, as a result of which these components behave like low-impedance resistors (often within the range of just a few milliohms) which establish a direct connection between the poles of the vehicle battery. In order to prevent a drop in voltage and a discharge of the vehicle battery, the control device should therefore be capable of detecting these faults and of reacting to them.

For this purpose, it is known that the integrated circuit that is provided for the actuation of the inverter, the gate-driver unit (GDU), exhibits a built-in monitoring of the drop in voltage arising at the switching elements between the drain electrode and the source electrode. However, such a monitoring is not as accurate and reliable as it should be, particularly in the field of high-performance electronics, since the MOSFETs that are used as switching elements in this field exhibit an on-resistance within the range of a few milliohms, and parasitic line resistances as well as differences between the various phases arise which influence the result of measurement. In addition, this type of monitoring does not offer any protection against short circuits in the charging capacitors, since these short circuits cannot be detected.

From DE 10 2014 114 716 A1 a monitoring device for a power-supply current is known for monitoring the intensity of a power-supply current in a driver circuit for an electric motor. The monitoring device exhibits a fault-determiner and a power-supply-relay controller. The fault-determiner determines, on the basis of a voltage across a shunt resistor through which the power-supply current is flowing, whether a short-circuit fault is occurring. The power-supply-relay controller opens and closes a power-supply relay, in order to isolate the inverter from a power-supply path and to connect it thereto. In order to eliminate a detection fault which has been caused, for instance, by noise or by a short circuit by reason of a transient switching contact, a recurrent monitoring process is carried out, in the course of which the power-supply relay is repeatedly switched ON and OFF once an overcurrent condition has been registered. A disadvantageous aspect of this monitoring device is that the measurement of the current in the power-supply path results in ohmic losses and does not permit a distinction between various causes of a short circuit.

The object of the invention is therefore to specify an electronic control device for actuating an electric motor, said device having improved short-circuit protection.

This object is achieved by an electronic control device with the features of claim 1.

By this means, an electronic control device is created for an electric motor of an electromechanical motor-vehicle steering system, the short-circuit protection of which is based on the evaluation of the flow of current through at least one capacitor connected in parallel with the inverter. The current-measuring device is consequently arranged in series with the at least one capacitor and in parallel with the inverter. The perception underlying the invention is that the current flowing through the capacitor in normal operation of the control device is a ripple current, the frequency of which depends on the switching frequency of the switching elements being used in the inverter. The direct-current component of the measured current is almost zero in normal operation. In the case of a short circuit, however, a direct-current component of the measured current arises—specifically, both when the capacitor has caused the short circuit and when a switching element of the inverter has caused the short circuit. A fault condition in the power module can therefore be detected reliably, regardless of the cause, via the direct-current component of the current flowing through the capacitor. A short-circuit fault signal can be output by the current-measuring device, for instance when the direct-current component strays from a predeterminable tolerance interval.

Furthermore, by virtue of the arrangement, according to the invention, of the current-measuring device in parallel with the inverter, it is ensured that in normal operation only a small fraction of the power current being used for supplying the electric motor flows through the measuring device, so that the ohmic losses of the control device are reduced.

In addition, the measuring arrangement according to the invention permits the two aforementioned causes of a short circuit to be distinguished from one another on the basis of the direction of the direct-current component. In the event of a short circuit in the at least one capacitor, a charging current of the capacitor passes through the capacitor unhindered, whereas in the event of a faulty switching element of the inverter the short circuit results in a discharge current in the capacitor. The current-measuring device is therefore preferentially designed to output a short-circuit fault signal that contains the direction of the direct-current component. In this case, the short-circuit fault signal can be drawn upon for a differentiated fault diagnosis.

The control unit preferentially contains a memory for storing the short-circuit fault signal. After the isolation of the electronic control device from the power source, the memory can then be read out, in order to be able to ascertain the cause of the short circuit even retrospectively.

Further configurations of the invention can be gathered from the following description and from the dependent claims.

The invention will be elucidated in more detail below with reference to an exemplary embodiment represented in the appended figures.

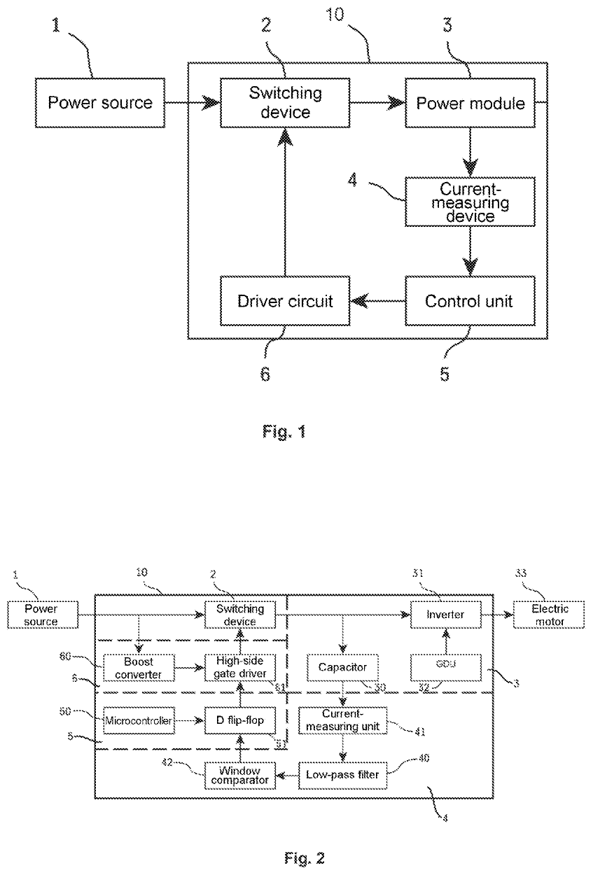

FIG. 1 shows schematically, in a block diagram, the structure of an electronic control device according to the invention, and

FIG. 2 shows schematically, in a block diagram, the structure of the electronic control device according to FIG. 1 in more detailed form.

In FIG. 1 the structure of an electronic control device with short-circuit protection for actuating an electric motor of an electromechanical motor-vehicle steering system, according to an exemplary embodiment of the invention, is represented schematically. The control device may take the form, for instance, of a separate control device or of a control device integrated into the electric motor.

The electronic control device 10 comprises a switching device 2, a power module 3, a current-measuring device 4 and a control unit 5. The electronic control device 10 is connected to a power source 1 via the switching device 2. Within the control device 10 the power module 3 is coupled to the switching device 2. An electric motor 33 (cf. FIG. 2) is capable of being coupled to the power module 3 for the supply of said motor with electrical power. The power module 3 contains an inverter 31 and at least one capacitor 30 connected in parallel with the inverter 31 (cf. FIG. 2). A current-measuring device 4 which is designed to output a short-circuit fault signal, depending on the intensity of an electric current arising in the power module 3, is connected to the power module 3. A control unit 5 for controlling the switching device 2 is connected to the current-measuring device 4, the control unit 5 being designed to trigger an isolation of the power module 3 from the power source 1 by means of the switching device 2 upon reception of the short-circuit fault signal. The current-measuring device 4 is furthermore designed to measure an electric current flowing through the capacitor 30 and to output the short-circuit fault signal on the basis of a direct-current component of the measured current. As represented in FIG. 1, the control of the switching device 2 can be undertaken by the control unit 5, preferentially with the aid of a driver circuit 6.

As represented in FIG. 2, the electronic control device 10 is connected between a power source 1, preferentially a DC voltage source such as a vehicle battery, for instance, and a preferentially multiphase electric motor 33 which is to be actuated and which, as part of an electromechanical motor-vehicle steering system, serves for assisting a steering movement of a driver. The power source 1 is connected via the switching device 2 to the power module 3 to which the electric motor 33 is coupled. The switching device 2 may preferentially contain at least two series-connected semiconductor switching elements which are actuated via the driver circuit 6. However the switching device 2 may alternatively also take the form of a switching relay, for instance.

The power module 3 includes, in addition to the at least one capacitor 30 and the inverter 31, a gate-driver unit (GDU) 32 which actuates the switching elements of the inverter 31. Semiconductor switching elements—in particular, MOSFETs or IGBTs—are preferentially provided as switching elements.

The at least one capacitor 30 serves as charging capacitor for smoothing the input voltage applied to the inverter 31. The capacitor 30 can consequently compensate for the fluctuating current demand of the inverter. In order to measure the current flowing through the capacitor 30, the current-measuring device 4 is arranged in series with the capacitor 30. The current-measuring device 4 preferentially includes a current-measuring unit 41 which converts the current to be measured into a voltage signal. The current-measuring unit 41 may, for instance, be designed to determine a drop in voltage at a shunt resistor connected in series with the capacitor 30. Alternatively, the current-measuring unit can also determine the current flowing through the capacitor by means of other measuring principles, for instance via the magnetic field brought about by the current to be measured.

The current-measuring device 4 preferentially further includes a low-pass filter 40 for determining the direct-current component of the current to be measured. The low-pass filter 40 filters out the alternating-current components of the ripple current flowing in the capacitor 30 as a result of the actuation of the electric motor 33. Since the current flowing through the capacitor 30 exhibits almost no direct-current component in normal operation, the output signal of the low-pass filter 40 lies within a tolerance around zero. The low-pass filter 40 is preferentially an active low-pass filter with DC voltage correction. The DC voltage correction can be undertaken by applying an adjustable offset voltage by which the output signal of the low-pass filter 40 has been calibrated substantially to zero in normal operation.

The output signal of the low-pass filter 40 can, as represented in FIG. 2, be supplied to a window comparator 42 of the measuring device 4, which outputs a short-circuit fault signal if the signal lies outside a predeterminable tolerance interval. The short-circuit fault signal can subsequently be fed to a D flip-flop 51 of the control unit 5, which is controlled by a microcontroller 50. With the aid of the D flip-flop, the short-circuit fault signal can be stored as a fault condition. This is advantageous in order to prevent the switching device 2 from being switched on again if the current measured at the capacitor 30, and hence the short-circuit fault signal, ceases to exist after the switching device 2 has been switched off.

As a result of the processing of the short-circuit fault signal in the control unit 5, short-circuit fault signals to be expected can, in addition, be distinguished from actual short-circuit faults, in order to avoid erroneous openings of the switching device 2. If the capacitor 30 is being charged for the first time, for instance when the ignition is being switched on, the current-measuring device 4 ascertains a direct-current component flowing through the capacitor 30, which is not founded on a short-circuit fault. The microcontroller 50 can therefore activate the D flip-flop preferentially only with a switch-on delay after the control device 10 has been switched on.

According to an exemplary embodiment which is not represented, the control unit may additionally contain a memory for storing the short-circuit fault signal. This memory preferentially takes the form of a non-volatile memory which can be read out, for instance for maintenance and/or repair of the control device. It is advantageous, furthermore, if the short-circuit fault signal contains the direction of the direct-current component. By the evaluation of the short-circuit fault signal in this case, diagnostic information can be obtained about the component that has caused the short-circuit fault.

On the basis of the output signal of the control unit 5, the switching device 2, as represented in FIG. 2, is actuated via a driver circuit 6, in order to isolate the power module 3 from the power source 1. For this purpose the driver circuit 6 preferentially includes a high-side gate driver 61, which is designed to isolate the power module 3 from the power source 1 even under load, and a boost converter 60 for supplying the high-side gate driver 61 with the switching voltage required for the switching device 2.

During the operation of the electronic control device 10, a monitoring process is consequently carried out continuously, in which the current-measuring device 4 monitors the direct-current component of the electric current flowing through the capacitor 30, the current-measuring device 4 outputs a short-circuit fault signal to the control unit 5 if the direct-current component strays from a predetermined tolerance interval, and the control unit 5 triggers the switching device 2 for the purpose of isolating the power module 3 from the power source 1 upon reception of the short-circuit fault signal. Subsequently the faulty power module 3 is isolated from the power source, so that a drop in the voltage of the power source 1 is prevented and other loads can continue to be operated properly at the power source 1. The control device 5 preferentially stores the appearance of the short-circuit fault signal as a fault condition, in order to prevent the switching device 2 from being switched on again after the short-circuit fault signal has ceased to exist.

### LIST OF REFERENCE SYMBOLS

1 power source

2 switching device

3 power module

4 current-measuring device

5 control unit

6 driver circuit

30 capacitor

31 inverter

32 gate-driver unit (GDU)

33 electric motor

40 low-pass filter

41 current-measuring unit

42 window comparator

50 microcontroller

D flip-flop

60 boost converter

61 high-side gate driver

1.-10. (canceled)

11. An electronic control device with short-circuit protection for actuating an electric motor of an electromechanical motor-vehicle steering system, the electronic control device comprising:
a switching device that is connectable to a power source;
a power module coupled to the switching device, wherein the power module is configured to be coupled to the electric motor for supplying electrical power, wherein the power module contains an inverter and a capacitor connected in parallel with the inverter;
a current-measuring device that is connected to the power module and that is designed to output a short-circuit fault signal based on an intensity of an electric current arising in the power module, wherein the current-measuring device is configured to measure an electric current flowing through the capacitor and configured to output the short-circuit fault signal based on a direct-current component of the measured electric current; and
a control unit connected to the current-measuring device for controlling the switching device, wherein the control unit is configured to trigger an isolation of the power module from the power source by way of the switching device upon receiving the short-circuit fault signal.

12. The electronic control device of claim 11 wherein the current-measuring device includes a current-measuring unit for determining a drop in voltage at a shunt resistor connected in series with the capacitor.

13. The electronic control device of claim 11 wherein the current-measuring device includes a low-pass filter for determining the direct-current component.

14. The electronic control device of claim 13 wherein the low-pass filter is an active low-pass filter with DC voltage correction.

15. The electronic control device of claim 11 wherein the switching device contains at least two series-connected semiconductor switching elements that are actuated via a driver circuit.

16. The electronic control device of claim 11 wherein the short-circuit fault signal contains or reveals a direction of the direct-current component.

17. The electronic control device of claim 11 wherein the control unit contains a memory for storing the short-circuit fault signal.

18. An electromechanical motor-vehicle steering system with an electric motor for assisting a steering movement of a driver, wherein the electric motor is actuated by the electronic control device of claim 11.

19. A method for operating the electronic control device of claim 11, the method comprising:
monitoring the direct-current component of the electric current flowing through the capacitor with the current-measuring device;
outputting the short-circuit fault signal with the current-measuring device to the control unit if the direct-current component deviates from a predetermined tolerance interval; and
triggering the switching device to isolate the power module from the power source upon receiving the short-circuit fault signal by the control unit.

20. The method of claim 19 wherein the control unit stores the short-circuit fault signal as a fault condition to prevent the switching device from being switched on again after the short-circuit fault signal has ceases to exist.
